(19) United States
(12) Patent Application Publication
(10) Pub. No.: US 2026/0357837 A1
(43) Pub. Date: Nov. 12, 2026

(54) ASSEMBLY DEVICE

(71) Applicant: Sumitomo Riko Company Limited, Aichi-ken (JP)

(72) Inventors: Martin GROMES, Steinau (DE); Christopher SETTNIK, Sinntal (DE)

(21) Appl. No.: 19/644,164

(22) Filed: Apr. 10, 2026

(30) Foreign Application Priority Data
May 7, 2025 (DE) 10 2025 117 452.0

(51) Int. Cl. F16B 7/20; B62D 65/02; F16F 15/08

(52) U.S. Cl. CPC F16B 7/20; F16F 15/08; B62D 65/02; F16F 2224/025

(57) ABSTRACT

The present disclosure relates to an assembly device comprising a first connector portion, a second connector portion and a first and second assembly element. The first and second assembly elements are each connected to one of the connector portions. Connecting contours are provided on the connector portions. A damping body is provided between the connector portions and the damping body is enclosed when the connector portions are connected.

### FIELD

The present disclosure relates to an assembly device comprising a first connector portion and a second connector portion, on which respective first and second assembly elements are provided, via which a device can be fastened to a body, for example a vehicle body. Such an assembly device is defined in the preamble of patent claim 1.

### BACKGROUND

US 2021/0310505 A1 discloses an assembly device, wherein a device can be attached to a vehicle body via the outer periphery of the assembly device, wherein a damping sleeve is provided between a hole in the vehicle body and an assembly bolt which holds a device to be fastened. Said assembly device consists of a multitude of complex components which have to be connected to each other, such that this type of device is not only cost-intensive to manufacture but also requires significant time, effort and/or cost to assemble.

CN 102275494 A discloses an assembly device in which a damping body which is arranged in a sleeve is provided between two assembly connectors which are provided with respective props. The overall arrangement is situated in a housing which is closed by press-fitting. This assembly device is relatively simple in design, but inflexible and requires a correspondingly adapted assembly device to be separately dimensioned for each application.

The prior art thus has the disadvantages that the known assembly devices are costly to manufacture, comparatively inflexible and require more time, effort and/or cost to assembly.

### SUMMARY

It is the object of the present embodiments to provide an improved assembly device which deals with at least one of the disadvantages in the prior art.

In accordance with the present embodiments, there is provided an assembly device comprising a first connector portion and a second connector portion. The first connector portion is connected to a first assembly element, and the second connector portion is connected to a second assembly element. The first and second connector portions are provided with corresponding connecting contours. The first and second assembly elements are embodied with end surfaces which lie opposite each other when the assembly device is assembled. The assembly device further comprises a damping body arranged between the end surfaces.

The first and second assembly elements may include respective end surfaces which can be embodied in a disc-like manner and between which the damping body is provided when the assembly device is assembled.

The two connector portions may advantageously be connected to each other by means of a rotational movement, wherein a damping body, which is embodied as a disc or pad, can be enclosed and/or press-fitted between the two connector portions, and wherein the damping body absorbs vibrations which would otherwise be transmitted from the first connector portion to the second connector portion or from the first assembly element to the second assembly element.

The assembly elements may be advantageously formed from metal, but can also be formed from a plastic material which may comprise, for example, reinforced with glass fibers.

The two connector portions may advantageously be formed from a metal, for example cast or die-cast aluminum, or from a plastic which may comprise, for example, reinforced with glass fibers, depending on the loads to which they are subjected when being used. Suitable plastic materials include PA66 or PA6, although the person skilled in the art will also be aware of additional appropriate plastic materials which can correspondingly be used.

The damping body can be manufactured from an elastomer, wherein the elastomer and its properties can be able to be adjusted in such a way that different damping properties can be achieved. The Shore hardness of the elastomer can for example be adjusted such that the assembly device is suitable for use in both motorcycles and passenger vehicles up to and including commercial vehicles, wherein the damping body can respond to and damp vibrations acting substantially axially on the first or second assembly element.

The first assembly element can advantageously be radially fixed to the connector portion assigned to it via a damping material, wherein the first assembly element can be injection-molded as an integral component, wherein the damping material is used. The damping material can then perform the radial damping function, such that the damping properties of the assembly device in accordance with the embodiments can also be substantially improved. Correspondingly, the second assembly element can also be injection-molded as an integral component onto the second connector portion via a corresponding damping material, as required. The damping material can also advantageously be adapted to the requirements when using the assembly device in accordance with the embodiments by selecting the material on the one hand and its Shore hardness on the other, in accordance with its area of application.

The connecting contours which can connect the first connector portion and the second connector portion to each other are advantageously embodied in such a way that movement or vibration in the axial direction is allowed, but the connector portions are prevented from decoupling. This may be achieved by embodying the connecting contours as a bayonet lock, wherein the bayonet lock can in particular be embodied in such a way that the first or the second connector portion has a longitudinal slot which extends in the axial direction and is discontinuously continued in the radial direction via an offset slot, wherein the other of the first and second connector portions is embodied with a holding region which can be held in the offset slot. The longitudinal slot above the offset slot provides the holding region with a free space in the axial direction. The first and second connector portions are thus held fixedly together, but can absorb vibration movements in the axial direction, wherein vibration movements in the radial direction or in the radially outward direction can be absorbed via the damping material.

In order to prevent the assembly device from being unintentionally opened, the connecting contours have an unlocking block portion which can for example be realized by a raised portion which extends in the axial direction and, in an embodiment, increasingly in a rotational direction. This can counteract the first connector portion becoming untwisted from the second connector portion during operation, i.e., when the assembly device is assembled; however, the assembly device in accordance with the embodiments can be untwisted or opened by applying a predetermined force, for example in order to replace the damping body.

An unlocking latch may be provided on the other connector portion in each case, in order to be able to co-operate with the unlocking block portion.

Instead of a bayonet lock, other connecting contours are also feasible which on the one hand enable a fixed connection, but allow vibration movements, in order to allow the damping body or the damping material to absorb vibrations. To this end, a clip lock which can be configured such that it can be rotated on the connector portions is for example feasible.

Embodiments are described in more detail below with reference to the accompanying figures, wherein identical components are denoted by identical reference signs and it is consequently unnecessary to repeatedly describe the same components.

### DRAWING DESCRIPTIONS

FIG. 1 shows a perspective side view of an assembly device of an embodiment in accordance with an embodiment.

FIG. 2 shows the embodiment in accordance with FIG. 1, when the assembly device is decoupled.

FIG. 3 shows cutaways of components of the decoupled embodiment shown in FIG. 2.

FIG. 4 shows an axial cross-section through the representation in accordance with FIG. 1, when the components of the assembly device are connected.

FIG. 5 shows the embodiment in accordance with an embodiment, when the assembly device is disassembled and split in two in the axial direction.

FIG. 6 shows the assembly device in accordance with FIG. 5, comprising a cutaway, when the assembly device is intermediately assembled, wherein the connecting contours (which in this case are embodied in the manner of a bayonet lock) are just about to engage each other.

FIG. 7 shows the representation in accordance with FIGS. 5 and 6, comprising a cutaway which shows the connecting contours in engagement with each other.

### DETAILED DESCRIPTION

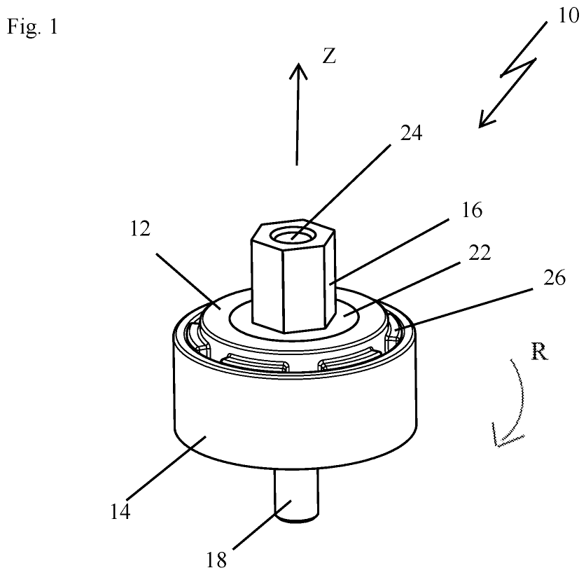

FIG. 1 shows an assembly device in accordance with a preferred embodiment. The assembly device 10 extends in the direction of its cylinder axis Z and is assembled in this direction, wherein a component which may be prone to vibrate is fixed to the upper end of a first assembly element 16 via a fixing part 24 and for example assembled on a vehicle body via a second assembly element 18. A first connector portion 12 and a second connector portion 14 which are situated between the first assembly element 16 and the second assembly element 18 are connected to each other via connecting contours 26 by a rotational movement in the direction R. The first assembly element 16 is molded, for example injection-molded as an integral component, onto the first connector portion 12 via a damping material 22. The damping material 22 can be manufactured from an elastomer, wherein different spring rates of the elastomer can be predetermined by means of different elastomers, depending on the loads to which it is subjected in a specific area of application. The spring rate of the elastomers can for example be predetermined by setting different Shore hardnesses.

The first and second connector portions 12, 14 can be manufactured from a plastic with or without the addition of glass fibers. The plastics PA66 and PA6 have proven to be favorable candidates for manufacturing the first and second connector portions 12, 14. If the components 12, 14 are to be subjected to greater loads, they can also be manufactured from a metal, for example die-cast aluminum.

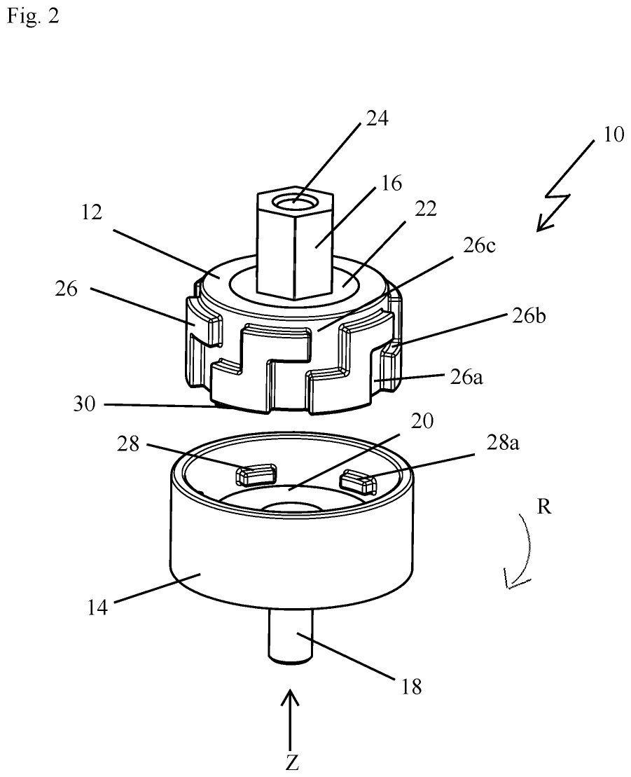

FIG. 2 shows the assembly device 10 in accordance with FIG. 1 when disassembled. Connecting contours 26 and 28 are shown here in detail. This is a specific embodiment of a bayonet lock, wherein the connecting contours 26 on the side of the first connector portion 12 have a longitudinal slot 26a, adjoined by an offset slot 26b which extends in the circumferential direction of the first connector portion 12, before the longitudinal slot 26a continues in the direction of the cylinder axis Z. A free space 26c enables vibration movements in the direction of the cylinder axis Z, even once the assembly device is assembled. In this way, vibrations in the direction of the cylinder axis Z can be absorbed by a damping body 20 which can advantageously be inserted into the second connector portion 14.

The damping properties of the damping body 20 can also be varied by using different elastomers, including for example rubber, and adapted in accordance with the stresses which occur.

The offset slot 26b of the connecting contour 26 on the first connector portion 12 serves to support a connecting contour 28 on the inner circumference of the second assembly element 18 when the assembly device is assembled. This connecting contour 28, which is embodied as a holding region 28a, rests on the offset slot 26b when the assembly device is assembled and is supported by the offset slot 26b in the opposite direction to the indicated direction of extension of the cylinder axis Z. When the assembly device is assembled, the holding region 28a which is embodied as a right-angled protruding stud has freedom of movement in the direction of the cylinder axis Z via the free space 26c, such that vibrations are not transmitted directly from the first connector portion 12 to the second connector portion 14 in the direction of the cylinder axis Z, but rather can be damped via the damping body 20.

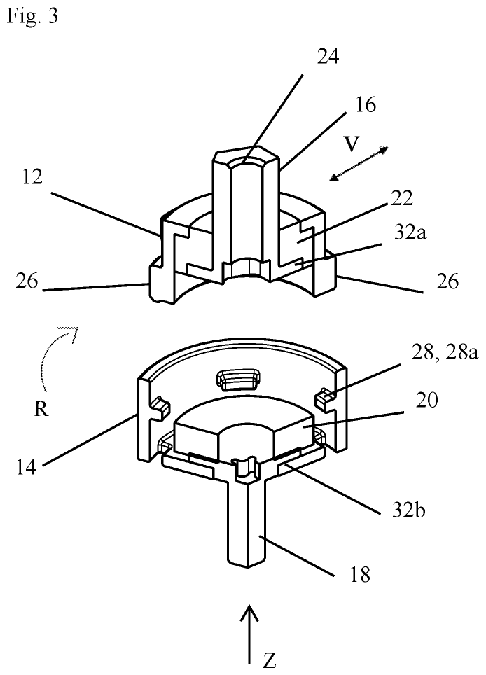

FIG. 3 is a perspective sectional representation showing details of the assembly device 10 in accordance with the embodiment presented here, showing that a connector disc 32b is attached to or integrally formed with the second assembly element 18 and that the damping body 20 lies on top of said connector disc 32b. The connector disc 32b can be molded into the material of the second connector portion 14, such that it is integrally embodied between the second assembly element 18 and the second connector portion 14 via the connector disc 32b.

The connector portions 12, 14 may be embodied in a cup-like manner.

The first assembly element 16 is also shown to be equipped with a connector disc 32, wherein the connector disc 32a and the adjoining end of the first assembly element 16 are molded, for example injection-molded as integral components, onto the first connector portion 12 via the damping material 22. Vibrations V not occurring in the direction of the cylinder axis Z can be mitigated and ideally absorbed, wherein the damping material 22 is used.

In accordance with the disclosed embodiments, the assembly device is capable of absorbing vibrations in all spatial directions. The damping properties of the material of the damping body 20 and the damping properties of the damping material 22 can be optimized by setting Shore hardnesses of the elastomers used in this case, in order to be able to satisfy specific installation environments.

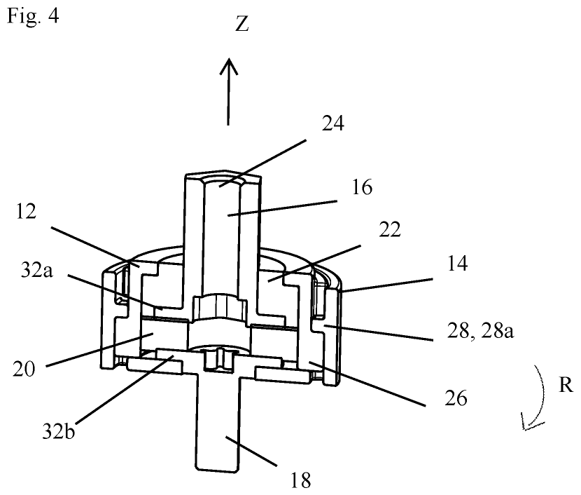

FIG. 4 shows a section through an assembly device when it is assembled, wherein the connecting contours 26, 28 are moved into mutual engagement by rotating one or both of the connector portions 12, 14 in a locking direction, wherein the damping body 20 is press-fitted between the connector discs or their end surfaces 32a, 32b in a predefined way in order to be able to absorb vibrations, wherein the damping body 20 predominantly absorbs vibrations occurring in the direction of the cylinder axis Z.

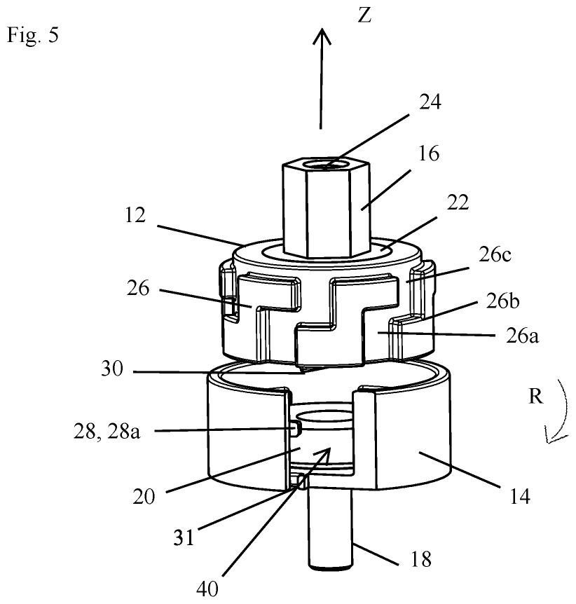

The damping material 22 absorbs vibrations which are perpendicular to the cylinder axis Z or occur in this direction. FIG. 5 shows the details of this embodiment of an assembly device in accordance with the embodiments in relation to a cutaway 40. A connecting contour 26 on the first connector portion 12 is introduced into a free region between holding regions 28a which are provided over a distance in the circumferential distance on the inner circumference of the second connector portion 14, wherein each holding region 28a which lies opposite a longitudinal slot 26a moves in the height direction of the offset slot 26b, and the first connector portion 12 can be moved in the direction R by being rotated, in order to move the holding region 28a to a position in which it lies on top of the offset slot 26b.

An unlocking block portion 30 which is provided at the lower end of at least one connecting contour 26 acts counter to the first connector portion 12 being unintentionally unlocked from the second connector portion 14. Embodying the protruding unlocking block portion 30 to be oblique can prevent the two connector portions 12, 14 from being able to be separated from each other by a rotational movement without applying greater disassembling forces, wherein an unlocking latch 31 prevents the unlocking block portion 30 from being able to be moved back during operation.

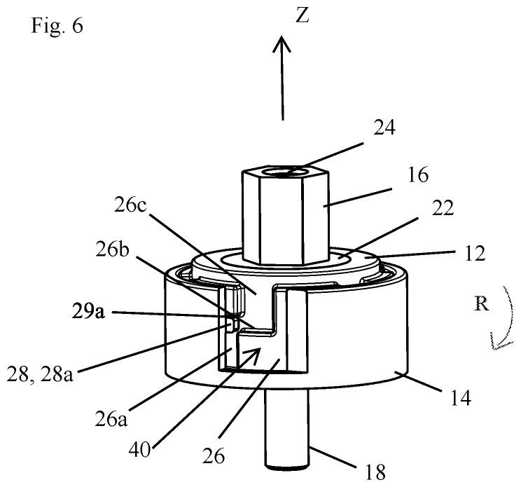

Also by providing a cutaway 40, the representation in FIG. 6 shows a process which leads to the first connector portion 12 being connected to the second connector portion 14. The holding region 28a on the second connector portion 14 is introduced into the longitudinal slot 26a until it abuts against a shoulder portion 26a of the connecting contour 26. By rotating at least one of the two connector portions 12, 14, the holding region 28a is then moved onto the offset slot 26b, in order to then come to rest in its end position in the region of the free space 26b.

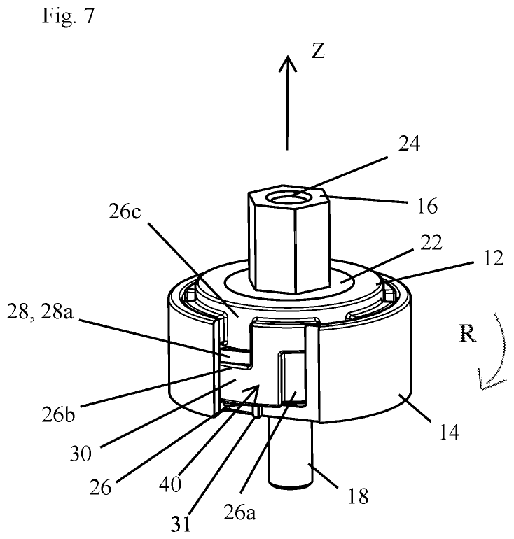

The aforementioned end position is clearly shown in FIG. 7, which shows that the holding region 28a is lying on top of the offset slot 26b, wherein the free space 26c enables vibration movements. The unlocking block portion 30, which has been moved via the unlocking latch 31 during the rotation which connects the first and second connector portions 12, 14, is also shown in the cutaway 40 in accordance with FIG. 7. In order to unlock the two connector portions 12, 14 from each other, the unlocking block portion 30 would have to be moved via the unlocking latch 31 in order to enable the two connector portions 12, 14 to be unlocked or separated, which should not be possible when the assembly device in accordance with the embodiments is in normal operation.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10 assembly device
12 first connector portion
14 second connector portion
16 first assembly element
18 second assembly element
20 damping body
22 damping material
24 fixing part
26, 28 connecting contours
26a longitudinal slot
26b offset slot
26c free space
28a holding region
29a shoulder portion
30 unlocking block portion
31 unlocking latch
32a, 32b connector disc, end surfaces
40 cutaway
V vibrations
Z cylinder axis
R rotational direction

1. An assembly device comprising:
a first connector portion; and
a second connector portion,
wherein the first connector portion is connected to a first assembly element,
wherein the second connector portion is connected to a second assembly element, and wherein:
the first and second connector portions are provided with corresponding connecting contours;
the first and second assembly elements are embodied with end surfaces which lie opposite each other when the assembly device is assembled; and
a damping body is arranged between the end surfaces.

2. The assembly device according to claim 1, wherein at least one of the first or second assembly elements (16, 18) is fixed, by means of a damping material (22), to the connector portion (12, 14) assigned to it (16, 18).

3. The assembly device according to claim 1 wherein the connecting contours allow movement or vibration in the axial direction (Z), but prevent the connector portions from decoupling.

4. The assembly device according to claims 2, wherein the connecting contours allow movement or vibration in the axial direction (Z), but prevent the connector portions from decoupling.

5. The assembly device according to claim 1, wherein connecting contours are embodied as a bayonet lock.

6. The assembly device according to claim 2, wherein connecting contours are embodied as a bayonet lock.

7. The assembly device according to claim 3, wherein connecting contours are embodied as a bayonet lock.

8. The assembly device according to claim 4, wherein connecting contours are embodied as a bayonet lock.

9. The assembly device according to claim 5, wherein one of the first or second connector portions has a longitudinal slot in an axial direction (Z), which is discontinuously continued in the radial direction (R) via an offset slot, wherein the other connector portion is embodied with a holding region which can be held in the offset slot, wherein the longitudinal slot above the offset slot provides the holding region with a free space in the axial direction (Z).

10. The assembly device according to claim 6, wherein one of the first or second connector portions has a longitudinal slot in an axial direction (Z), which is discontinuously continued in the radial direction (R) via an offset slot, wherein the other connector portion is embodied with a holding region which can be held in the offset slot, wherein the longitudinal slot above the offset slot provides the holding region with a free space in the axial direction (Z).

11. The assembly device according to claim 7, wherein one of the first or second connector portions has a longitudinal slot in an axial direction (Z), which is discontinuously continued in the radial direction (R) via an offset slot, wherein the other connector portion is embodied with a holding region which can be held in the offset slot, wherein the longitudinal slot above the offset slot provides the holding region with a free space in the axial direction (Z).

12. The assembly device according to claim 8, wherein one of the first or second connector portions has a longitudinal slot in an axial direction (Z), which is discontinuously continued in the radial direction (R) via an offset slot, wherein the other connector portion is embodied with a holding region which can be held in the offset slot, wherein the longitudinal slot above the offset slot provides the holding region with a free space in the axial direction (Z).

13. The assembly device according to claim 3, wherein the connecting contours have an unlocking block portion.

14. The assembly device according to claim 4, wherein the connecting contours have an unlocking block portion.

15. The assembly device according to claim 13, wherein an unlocking latch is provided which co-operates with the unlocking block portion.

16. The assembly device according to claim 14, wherein an unlocking latch is provided which co-operates with the unlocking block portion.
